(19) United States
(12) Patent Application Publication
(10) Pub. No.: US 2015/0046626 A1
(43) Pub. Date: Feb. 12, 2015

(54) LOW POWER SECONDARY INTERFACE ADJUNCT TO A PCI EXPRESS INTERFACE BETWEEN INTEGRATED CIRCUITS

(71) Applicant: Samsung Electronics Co., Ltd., Gyeonggi-do (KR)

(72) Inventor: Michael J. COWELL, Cambridgeshire (GB)

(73) Assignee: Samsung Electronics Co., Ltd., Gyeonggi-do (KR)

(21) Appl. No.: 14/078,049

(22) Filed: Nov. 12, 2013

Related U.S. Application Data
(60) Provisional application No. 61/864,896, filed on Aug. 12, 2013.

(51) Int. Cl. G06F 13/40; G06F 13/42

(52) U.S. Cl. CPC G06F 13/4068; G06F 13/4295
USPC 710/313

(57) ABSTRACT

A method, apparatus, and system for a secondary/adjunct interface between two Integrated Circuits (ICs) already having a Peripheral Component Interconnection Express (PCIe) interface, where the PCIe interface performs high-throughput data transfers and the adjunct/secondary interface performs low-throughput data transfers, thereby reducing power consumption for the low-throughput data transfers, are described.

### PRIORITY

This application claims priority under 35 U.S.C. §119(e) to U.S. Provisional Patent Application Ser. No. 61/864,896 filed on Aug. 12, 2013, the entire disclosure of which is incorporated herein by reference.

### BACKGROUND OF THE INVENTION

1. Field of the Invention

The present invention relates generally to providing a second interface alongside a Peripheral Component Interconnect Express (PCI Express, also abbreviated PCIe) interface, and more particularly, to providing a secondary interface which performs low throughput data transfers for latency-constrained applications instead of the primary PCIe interface, and also has low quiescent power.

2. Description of the Related Art

PCIe is a standard, promulgated by the Peripheral Component Interconnect Special Interest Group (PCI-SIG), for a high-speed serial interconnection for data transfer between electronic devices and/or components.

FIG. 1 is a block diagram of a typical implementation of PCIe architecture, with a Device Integrated Chip (IC) 100 being interconnected via PCIe with a Host IC 200, where the expected bulk data flow is Device IC 100 transferring data, typically using a Direct Memory Access (DMA) controller, to and/or from memory storage in and/or connected to Host IC 200. However, FIG. 1 does not show the endpoints of the data transfer, but rather the Network-on-a-Chip (NoC) Fabric 130 and 230 in Device IC 100 and Host IC 200, respectively, which would route the data to the appropriate component in this specific implementation. Although the endpoints are highly application specific, the endpoints for bulk data transfers are likely to be an off-chip DRAM on the host side and an on-chip buffer memory on the device side

The Device IC 100 and Host IC 200 are connected by functionally identical PCIe PHYsical layer interfaces (PCIe PHYs) 110 and 210, respectively, which effectively form the bridge between NoC Fabrics 130 and 230 in Device IC 100 and Host IC 200, and which communicate with each other using the PCIe protocol. Each of PHY 110 and 210 communicate with their respective Core components in their respective ICs using the PHY Interface for PCI Express (PIPE), as shown in FIG. 1. Host IC 200 has PCIe Root Complex (RC) Core 220, and Device IC 100 has PCIe EndPoint (EP) Core 120. Since RC Core 220 assigns system level addresses for the data transfer, EP Core 120 includes address translation logic, since it is likely that the system addresses assigned by Host IC 200 will be incompatible with Device IC 100's address map.

In the specific implementation shown in FIG. 1, both the Host and Device ICs 100 and 200 use Advanced Microcontroller Bus Architecture (AMBA) as an on-chip bus, and thus NoC Fabrics 130 and 230 communicate with Cores 120 and 220, respectively, using the Advanced eXtensible Interface 4 (AXI4) according to the AMBA 4 specification. AXI is commonly used for on-chip interconnections in mobile terminals, such as cellular telephones, tablet computers, and laptop computers.

For latency-constrained applications, while PCIe is relatively efficient at higher data transfer rates, PCIe has a “power floor” at lower data transfer rates, as shown by the chart of throughput vs. power in FIG. 3. At throughputs of about 1000 KiloByte/second (kBps) and below, the same amount of power is used for data transfer, no matter how low the throughput is. This power floor may be as a high as a few milliwatts (mWs), depending on the implementation. This is because PCIe relies on a gigahertz phase-locked-loop (PLL) being active for any transfer of data, and the start-up time of this component is on the order of a millisecond minimum. If the maximum permissible latency for the data transfer is ˜100 ms (not uncommon in many applications), a minimum 1% duty cycle of a very high power (on the order of a hundred milliwatts) circuit is required.

Thus, there is a need for a system, apparatus, and method for reducing the power consumption of an IC using a PCIe interface for data transfer at lower throughput rates, particularly for data transfers involving latency-constrained applications.

### SUMMARY OF THE INVENTION

The present invention addresses at least the problems and disadvantages described above and provides at least the advantages described below. According to one aspect of the invention, an adjunct interface in addition to a high speed serial data interface that uses a current loop for signaling, such as a Serial Advanced Technology Attachment (SATA), a Universal Serial Bus, or the PCIe interface, is provided for low throughput data transfers between ICs. According to another aspect of the present invention, the adjunct interface uses Complementary Metal Oxide Semiconductor (CMOS) input/output (I/O) technology, thereby reducing power consumption when not in use (i.e., low quiescent power). According to yet another aspect of the present invention, the adjunct interface uses a synchronous signaling scheme with a relatively slow clock, thereby eliminating any wasteful startup/shutdown sequence and reducing power consumption by being active only when data is being transferred. According to still another aspect of the present invention, the adjunct interface is implemented using protocol semantics such that foreground device/host software need not be aware a non-PCIe interface is being used in addition to the PCIe interface.

According to one embodiment of the present invention, a system in a mobile terminal includes a Host Integrated Circuit (IC) which includes a first Peripheral Component Interconnection Express (PCIe) interface configured for data transfer with a second PCIe interface of a Device IC; and a first adjunct interface configured for low-throughput data transfer with a second adjunct interface of the Device IC, wherein the first PCIe interface performs only high-throughput data transfer; and the Device IC includes the second PCIe interface configured for data transfer with the first PCIe interface of the Host IC; and the second adjunct interface configured for low-throughput data transfer with the first adjunct interface of the Host IC, wherein the second PCIe interface performs only high-throughput data transfer.

According to another embodiment of the present invention, an Integrated Circuit (IC) includes a Peripheral Component Interconnection Express (PCIe) interface configured for data transfer with at least one other IC; an adjunct interface configured for using synchronous signaling via a plurality of Complementary Metal Oxide Semiconductor (CMOS) Input/Output (I/O) lanes for low-throughput data transfer with the at least one other IC; and a routing module configured to separate and provide low-throughput data transfers with the at least one other IC to the adjunct interface instead of the PCIe interface.

According to yet another embodiment of the present invention, a method for transferring data between Integrated Circuits (ICs) having a Peripheral Component Interconnection Express (PCIe) interface includes separating low-throughput data transfers from high-throughput data transfers; performing the high-throughput data transfers with the PCIe interface; and performing the low-throughput data transfers with an adjunct interface having an interconnect between the ICs comprising a plurality of Complementary Metal Oxide Semiconductor (CMOS) Input/Output (I/O) lanes.

According to still another embodiment of the present invention, a method of manufacturing an adjunct interconnect between a Host Integrated Circuit (IC) and a Device IC to be connected by a Peripheral Component Interconnection Express (PCIe) interface includes forming a plurality of Complementary Metal Oxide Semiconductor (CMOS) Input/Output (I/O) lanes configured to carry synchronous signaling of low-throughput data transfers between the Host IC and Device IC, where the PCIe interface is used for high-throughput data transfers between the Host IC and Device IC.

According to a still further embodiment of the present invention, a system in a mobile terminal includes a Host Integrated Circuit (IC) including a first high speed serial data interface that uses a current loop for signaling a second high speed serial data interface of a Device IC, the first high speed serial data interface being configured to perform only high-throughput data transfer; and a first adjunct interface configured for low-throughput data transfer with a second adjunct interface of the Device IC, wherein the first PCIe interface performs only high-throughput data transfer; a plurality of Complementary Metal Oxide Semiconductor (CMOS) Input/Output (I/O) lanes connecting the first adjunct interface of the Host IC with the second adjunct interface of the Device IC, the plurality of CMOS I/O lanes configured for synchronous low-throughput data transfer; and the Device IC including the second high speed serial data interface configured for data transfer with the first high speed serial data interface of the Host IC; the second adjunct interface configured for low-throughput data transfer with the first adjunct interface of the Host IC using the plurality of CMOS I/O lanes; and a routing module configured to separate low-throughput data from high-throughput data.

### BRIEF DESCRIPTION OF THE DRAWINGS

The above and other aspects, features and advantages of certain embodiments of the present invention will become more apparent from the following detailed description taken in conjunction with the accompanying drawings, in which:

FIG. 1 is a block diagram showing a typical architecture of a Host Integrated Circuit (IC) and a Device IC connected by a Peripheral Component Interconnect Express (PCIe) interface, to which an embodiment of the present invention is applied;

FIG. 2 is a block diagram showing the architecture of Host and Device ICs connected by a PCIe interface and a secondary/adjunct interface according to an embodiment of the present invention; and

FIG. 3 is a chart comparing, using a computer model, the power used by the typical PCIe architecture and the power used by the PCIe/adjunct architecture according to an embodiment of the present invention.

### DETAILED DESCRIPTION OF EMBODIMENTS OF THE PRESENT INVENTION

Various embodiments of the present invention will be described in detail below with reference to the accompanying drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

According to embodiments of the present invention, a secondary/adjunct interface is provided to an IC having a high speed serial data interface that uses a current loop for signaling, such as a Serial Advanced Technology Attachment (SATA), a Universal Serial Bus (USB), or the PCIe interface, with another component, where the high speed serial data interface performs high-throughput data transfers and the adjunct/secondary interface performs low-throughput data transfers, thereby reducing IC power consumption for the low-throughput data transfers. While embodiments of the present invention are primarily directed to latency-constrained applications, the present application has applicability to almost any application, since, in practice, any application will have some sort of latency constraint.

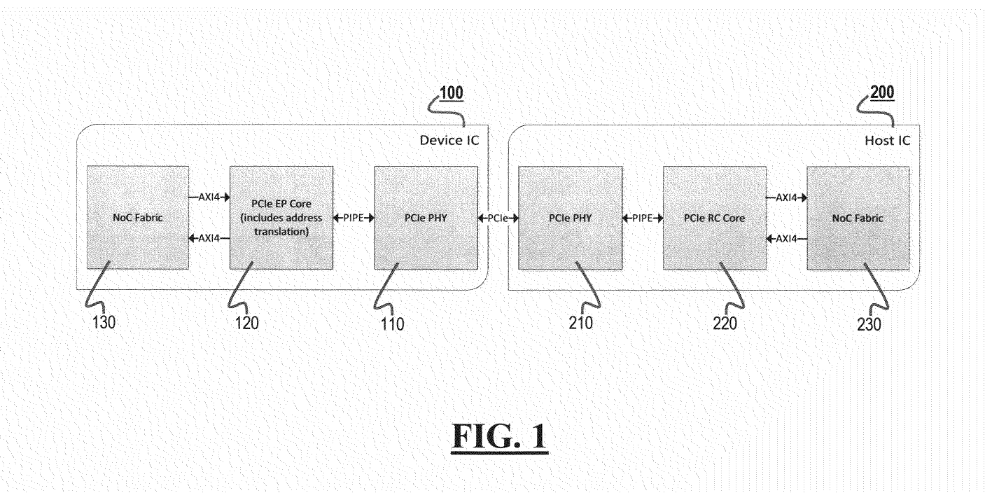

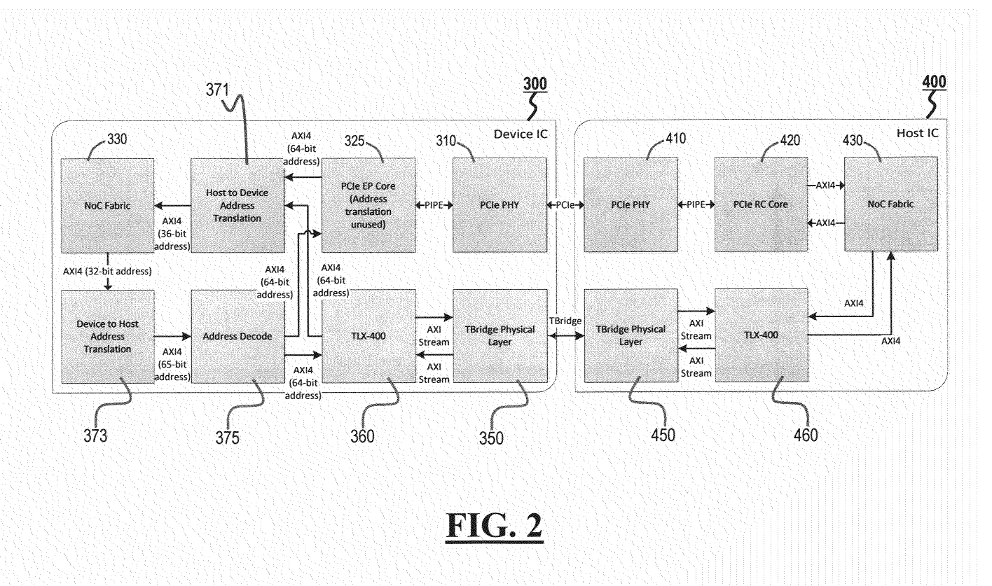

FIG. 2 is a block diagram showing a Device IC 300 being interconnected via PCIe with a Host IC 400 in a manner similar to FIG. 1, except that Device IC 300 and Host IC 400 are also interconnected by an adjunct/secondary interface according to an embodiment of the present invention.

Similar to FIG. 1, Device and Host ICs 300 and 400 have PHY interfaces 310 and 410, EP and RC Cores 325 and 420, and NoC Fabrics 330 and 430, respectively. Unlike EP Core 120 in FIG. 1, EP Core 325 in FIG. 2 does not use address translation. In practice, EP Core 325 may have identical circuitry to EP Core 120, but does not use its capacity to perform address translation. Also similar to FIG. 1, both the Host and Device ICs 300 and 400 in FIG. 2 use Advanced Microcontroller Bus Architecture (AMBA) as an on-chip bus, and thus their respective internal components communicate using the Advanced eXtensible Interface 4 (AXI4) according to the AMBA 4 specification. Other embodiments of the present invention may use other types of on-chip busses, and/or it is possible the Device and Host ICs may use different on-chip busses, as long as appropriate modifications are made to the adjunct interface, as would be understood by one of ordinary skill in the art.

In FIG. 2 there is an additional interconnect between TBridge Physical Layer Module 350 in Device IC 300 and TBridge Physical Layer Module 450 in Host IC 400. In this embodiment, the TBridge Physical Layer Modules 350 and 450 are connected by up to 4 Complementary Metal Oxide Semiconductor (CMOS) Input/Output (I/O) lanes in each direction, with data protection through Cyclic Redundancy Checks (CRCs) and retries. TBridge Physical Layer Modules 350 and 450 can operate in single or dual clock synchronous mode, where single clock synchronous mode only requires 3 I/O lanes. Clock suppression is supported in order to reduce power consumption when not transmitting data.

As indicated by their names, TBridge Physical Layer Modules 350 and 450 comprise the physical layer of the adjunct/secondary interface, and thus their internal (i.e., on-chip) input/output is to and from the data/transport layer, whose function is performed by CoreLink TLX-400 Network Interconnect Thin Links modules 360 and 460 in Device IC 300 and Host IC 400, respectively, in this specific embodiment. The TLX-400 Thin Links is an ARM product (described in ARM document ARM DSU 0028A, which is hereby incorporated by reference) that acts as a data interface between AXI4 I/O on one side and AXI-Stream I/O on the other. Thus, in Device IC 300, TLX-400 360 has AXI-Stream I/O with TBridge Physical Layer Module 350 on one side, and AXI4 I/O with various internal address decoding/translation components (to be discussed further below) on the other. Similarly, TLX-400 460 in Host IC 400 has AXI-Stream I/O with TBridge Physical Layer Module 450 on one side, and AXI4 I/O with NoC Fabric 430 on the other. The data/transfer layer, in this case, TLX-400 360 and 460, handles at least the packet buffering, flow control, access arbitration, channel identification and packing.

In order to perform the address translation which is usually required on the Device IC, and normally performed by EP Core 120 as shown in FIG. 1, Device IC 300 has Host-to-Device Address Translation Module 371, Device-to-Host Address Translation Module 373, and Address Decoder/Router Module 375. All of the low-throughput data transferring into Device IC 300 is output from TLX-400 360 to Host-to-Device Address Translation Module 371, which performs part of the task of address translation typically performed by EP Core 325, namely, translating the Host IC system addresses to Device IC system addresses. Host-to-Device Address Translation Module 371 also performs this translation function for the high-throughput data from the EP Core 325 which transferred into Device IC 300 from the Host IC PCIe interface. Once the addresses are translated, the data is input into the NoC Fabric 330 of the Device IC 300.

Data being transferred out of NoC Fabric 330 is provided to Device-to-Host Address Translation Module 373, which performs the reciprocal operation to Host-to-Device Address Translation Module 371, i.e., translating the Device IC addresses to Home IC addresses. Once the addresses are translated, the data is input into Address Decoder/Router Module 375, which serves the function of separating and routing low-throughput and high-throughput data transfers. In this embodiment, an extra bit is added to the address of the AXI4 flow from the Device-to-Host Address Translation Module 373, where the bit acts as a simple binary flag indicating the data is either for high-throughput data transfer through the PCIe interface (e.g., bit=1) or for low-throughput data transfer through the adjunct/secondary interface (e.g., bit=0). The appropriate bit value may be retrieved from one or more tables which are indexed by component addresses. Address Decoder/Router Module 375 both removes the flag bit from the address and routes the data either to EP Core 325, if high-throughput, or TLX-400, if low-throughput.

By means of these components, all necessary address translation is still done on Device IC 300—but it is pulled out of the EP Core 325 360. Between this and the single routing bit, this embodiment has minimal system impact, and has the effect of merging interface selection/routing into address translation (which would typically be done in a background task). In this embodiment, it is assumed, as in most applications, that host-initiated data transfers are minimal (mainly control/status information) and thus Host IC 400 has no need for a dynamic address translation scheme. However, in embodiments where Host IC 400 was mastering most data traffic, extra hardware like the components in Device IC 300 could be added to Host IC 400.

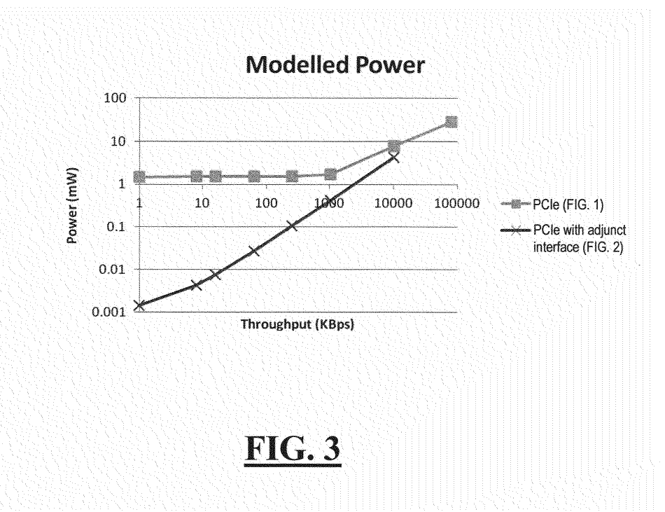

What data rate is considered high-throughput and low-throughput depends somewhat on the implementation, but one of ordinary skill in the art would recognize the appropriate breaking point in KBps for use of the adjunct/secondary interface rather than the PCIe interface, as will be discussed in reference to FIG. 3 further below. The specific implementation, especially the overall system configuration, will also affect where the threshold between low and high throughput will be set. Furthermore, in some embodiments, it is possible the system may be adaptive, and change the threshold based on system and/or environmental conditions. However, embodiments of the present invention would normally have the threshold between low and high throughput at least above the PCIe interface's low “power floor” discussed above.

The additional logic needed to implement this embodiment (vs. a typical PCIe implementation) is likely to be around 50,000 gates, or less than 0.05 mm² on a modern digital process. Given that a typical PCIe PHY is on the order of 1 mm², this means the area used to implement the adjunct/secondary interface is only a few percent (at most, given that the PHY does not represent the whole area consumed by PCIe). If overlaying is used, the extra I/O cost may only be 1 CMOS I/O. Moreover, although this embodiment requires extra CMOS I/O, it may be possible to replace some existing PCIe sideband signals, such as the CLKREQ or PME signals, as these requests could be virtualized over the adjunct/secondary interface.

In this embodiment, the adjunct/secondary interface reduces power consumption in the physical layer by using CMOS I/O interface technology, which suffers from only a minimal leakage current when in an inactive state (i.e. sub-threshold source/drain, gate/drain currents, which are on the order of microamps), as opposed to the differential I/O technology used in PCIe (which has an active current loop even when not transmitting/receiving). These currents are across hundreds of millivolt (or more) I/O rails, so they can possibly result in significant power consumption.

In this embodiment, the adjunct/secondary interface obviates the need for any time-consuming training or PLL start-up/shutdown sequences in the physical layer by using synchronous signaling (i.e. sending clock with data) with a slow (sub-gigahertz) clock, resulting in active power only being consumed when data is being transferred.

In this embodiment, the protocol semantics used very closely correspond to PCIe protocol semantics so that foreground device/host software need not necessarily be aware that a different interface is being used. In other embodiments, interface selection (i.e., low- and high-throughput routing in the device IC) can be done and/or assisted by long term background processing loops.

As a result of these features, this embodiment of the present invention provides a low power alternative when the high speed differential I/O data transfer provided by the PCIe interface is not required and/or is highly inefficient (i.e., wasteful of resources). Moreover, this embodiment of the present invention provides backwards compatibility with existing implementations of PCIe, and minimizes system impact at both the software and hardware level.

FIG. 3 is a chart comparing, using a computer model, the power used by the typical PCIe architecture in FIG. 1 and the power used by the PCIe/adjunct architecture according to the embodiment of the present invention in FIG. 2. As can be seen therein, power consumption in the sub-1 MBps range is dramatically reduced for the PCIe/adjunct architecture. Power consumption in the sub-10 KBps range is reduced by a number of orders of magnitude. As mentioned above, the chart in FIG. 3 can assist determining the line between low-throughput and high-throughput data transfer, i.e., which data traffic goes through the PCIe interface and which traffic goes through the adjunct/secondary interface. Whatever exact threshold value is chosen, FIG. 3 helps make the point that this embodiment of the present invention reduces host interface power consumption by an order of magnitude in low throughput use cases, without significant impact to system software and/or adding much new hardware (only a few percentage points added to the PCIe solution).

In this embodiment of the present invention, the secondary/adjunct interface has both a data/transport layer (TLX-400 360 and 460) and a physical layer (TBridge Physical Layer Modules 350 and 450). According to embodiments of the present invention, only implementation of the data/transport layer is strictly necessary, as the inefficiency in the PCIe is in this layer, but implementing both layers as in FIG. 2 decreases effort, as the existing PCIe implementations need not be modified to implement the adjunct/secondary interface. In this embodiment, it is assumed that both ICs (device and host) use AXI for on-chip interconnect (this is common in mobile applications), but the same approach will serve for other interconnect technologies.

There are a number of possible alternative embodiments of the invention. For example, as mentioned above, the adjunct/secondary interface according to the present invention is applicable to any situation where the primary interface was a high speed serial data interface that uses a current loop for signaling, such as a SATA or USB interface. As another example, the physical layer of the adjunct interface according to the present invention may comprise any synchronous configuration of CMOS I/O lanes with appropriate error recognition/correction.

As mentioned above, in some embodiments, some or all of the components of the FIG. 2 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a non-transitory computer-readable medium so as to enable or configure the computer-readable medium and/or one or more associated computing systems or devices to execute or otherwise use or provide the contents to perform at least some of the described techniques. Moreover, in alternative embodiments, hard-wired circuitry may be used in place of or in combination with software instructions to implement the invention. Thus, embodiments of the invention are not limited to any specific combination of hardware circuitry and software.

The term “non-transitory computer-readable medium” as used herein refers to any medium that participates in providing instructions to a processor for execution, and may take many forms, including but not limited to, non-volatile media, volatile media, and transmission media. Non-volatile media includes, for example, a floppy disk, a flexible disk, hard disk, magnetic tape, or any other magnetic storage medium, a CD-ROM, DVD, and/or any other optical storage medium. Volatile media includes dynamic random access memory (“DRAM”), RAM, PROM, EPROM, FLASH-EPROM, and the like. Transmission media includes coaxial cables, copper wire and fiber optics, including, e.g., the CMOS I/O interface connecting TBridge Physical Layer Modules 350 and 450.

While several embodiments have been described, it will be understood that various modifications can be made without departing from the scope of the present invention. Thus, it will be apparent to those of ordinary skill in the art that the invention is not limited to the embodiments described, but can encompass everything covered by the appended claims and their equivalents.

What is claimed is:

1. A system in a mobile terminal, comprising:
a Host Integrated Circuit (IC) comprising:
a first Peripheral Component Interconnection Express (PCIe) interface configured for data transfer with a second PCIe interface of a Device IC; and
a first adjunct interface configured for low-throughput data transfer with a second adjunct interface of the Device IC, wherein the first PCIe interface performs only high-throughput data transfer; and
the Device IC comprising:
the second PCIe interface configured for data transfer with the first PCIe interface of the Host IC; and
the second adjunct interface configured for low-throughput data transfer with the first adjunct interface of the Host IC, wherein the second PCIe interface performs only high-throughput data transfer.

2. The system of claim 1, further comprising:
a plurality of Complementary Metal Oxide Semiconductor (CMOS) Input/Output (I/O) lanes connecting the first adjunct interface of the Host IC with the second adjunct interface of the Device IC, the plurality of CMOS I/O lanes configured for synchronous low-throughput data transfer.

3. The system of claim 1, wherein the Device IC further comprises:
a routing module configured to separate low-throughput data from high-throughput data.

4. The system of claim 3, wherein the routing module separates low-throughput data from high-throughput data based on a threshold value.

5. The system of claim 4, wherein the threshold value is between about 10 to 10,000 kilobytes per second.

6. The system of claim 1, wherein each of the adjunct interfaces comprises:
a physical layer module configured for data transfer with a corresponding physical layer module in the other IC.

7. The system of claim 6, wherein each of the adjunct interfaces further comprises:
a data layer module configured for data transfer with the physical layer module.

8. The system of claim 1, wherein the Device IC further comprises:
a host-to-device address translation module configured for translating Host IC addresses in incoming data transfers to Device IC addresses; and
a device-to-host address translation module configured for translating Device IC addresses in outgoing data transfers to Home IC addresses.

9. An Integrated Circuit (IC), comprising:
a Peripheral Component Interconnection Express (PCIe) interface configured for data transfer with at least one other IC;
an adjunct interface configured for using synchronous signaling via a plurality of Complementary Metal Oxide Semiconductor (CMOS) Input/Output (I/O) lanes for low-throughput data transfer with the at least one other IC; and
a routing module configured to separate and provide low-throughput data transfers with the at least one other IC to the adjunct interface instead of the PCIe interface.

10. A method for transferring data between Integrated Circuits (ICs) having a Peripheral Component Interconnection Express (PCIe) interface, comprising:
separating low-throughput data transfers from high-throughput data transfers;
performing the high-throughput data transfers with the PCIe interface; and
performing the low-throughput data transfers with an adjunct interface having an interconnect between the ICs comprising a plurality of Complementary Metal Oxide Semiconductor (CMOS) Input/Output (I/O) lanes.

11. A method of manufacturing an adjunct interconnect between a Host Integrated Circuit (IC) and a Device IC to be connected by a Peripheral Component Interconnection Express (PCIe) interface, comprising:
forming a plurality of Complementary Metal Oxide Semiconductor (CMOS) Input/Output (I/O) lanes configured to carry synchronous signaling of low-throughput data transfers between the Host IC and Device IC, where the PCIe interface is used for high-throughput data transfers between the Host IC and Device IC.

12. A system in a mobile terminal, comprising:
a Host Integrated Circuit (IC) comprising:
a first high speed serial data interface that uses a current loop for signaling a second high speed serial data interface of a Device IC, the first high speed serial data interface being configured to perform only high-throughput data transfer; and
a first adjunct interface configured for low-throughput data transfer with a second adjunct interface of the Device IC, wherein the first PCIe interface performs only high-throughput data transfer;
a plurality of Complementary Metal Oxide Semiconductor (CMOS) Input/Output (I/O) lanes connecting the first adjunct interface of the Host IC with the second adjunct interface of the Device IC, the plurality of CMOS I/O lanes configured for synchronous low-throughput data transfer; and
the Device IC comprising:
the second high speed serial data interface configured for data transfer with the first high speed serial data interface of the Host IC;
the second adjunct interface configured for low-throughput data transfer with the first adjunct interface of the Host IC using the plurality of CMOS I/O lanes; and
a routing module configured to separate low-throughput data from high-throughput data.

13. The system of claim 12, wherein the first and second high speed serial interfaces comprises at least one of Serial Advanced Technology Attachment (SATA), Universal Serial Bus, or Peripheral Component Interconnection Express (PCIe) interfaces.
